(19) United States
(12) Patent Application Publication
(10) Pub. No.: US 2004/0067850 A1
(43) Pub. Date: Apr. 8, 2004

(54) Agricultural and horticultural composition

(76) Inventor: Sofia Wahlberg, Skurup (SE)

Correspondence Address: BURNS DOANE SWECKER & MATHIS L L P, POST OFFICE BOX 1404, ALEXANDRIA, VA, 22313-1404, US

(21) Appl. No.: 10/469,044

(22) PCT Filed: Mar. 18, 2002
(86) PCT No.: PCT/SE02/00513

(30) Foreign Application Priority Data
Mar. 19, 2001 (SE) 01009497

(51) Int. Cl. A01N 25/00

(52) U.S. Cl. 504/116.1

(57) ABSTRACT

The prestn invention relates to a composition for resorption of micro-nutrients in plants, or pre-stages thereof, containing a micro-nutrient agent, an organic acid and an amino acid. the composition is obtainable by addition of at least on oxidizing agent during preparation of the composition, for oxidation of the micro-nutrient agent. A method of producing said composition and use of said compostion are also described.

### FIELD OF THE INVENTION

The present invention relates to a composition for resorption of micro-nutrients in plants, or pre-stages thereof, containing a micro-nutrient agent, an organic acid and an amino acid, a method of producing said composition and the use of said composition.

### BACKGROUND OF THE INVENTION

In the agricultural and horticultural section the need for addition of micro-nutrients is a problem that has been recognised for a long time. The state of the soil, the minerals present, the pH value and other factors, have an influence on to what extent micro-nutrients are available to the plant. Lack of micro-nutrients in the soil or unfavourable conditions for micro-nutrient resorption lead to weaker plant growth and to lower yield of the crop.

Lack of micro-nutrients or low resorption of micro-nutrients, cannot be compensated with an increase in available macro-nutrients. The lack of resorption of micro-nutrients will also reduce the effect of other nutrients with a considerable negative effect on crop yield and financial outcome for the grower.

Substances regarded as micro-nutrients are ions of manganese, boron, iron, copper, zink, molybdenum, cobalt, aluminium, vanadium, nickel, sodium, selenium, chlorine, fluorine and iodine (“Development, Visual and Analythical Diagnosis”, edited by Werner Bergmann, publisher Gustav Fischer, ISBN 3-334-60422-5).

Uptake, or resorption, of micro-nutrients is complex and not fully understood. It is however generally recognised that the micro-nutrient must be in solution or presented to the plant in a dispersed state e.g. in a complexed form, regardless to which part of the plant the micro-nutrient is administered.

Many attempts have previously been made, with various degrees of success, in order to increase the plant's uptake of micro-nutrients. One example of such an attempt is the use of polymer sesquestrants as described in U.S. Pat. No. 3,980,462. In U.S. Pat. No. 4,425,149 the use of leonardite ore as a chelating agent is described. The final product according to U.S. Pat. No. 4,425,149 is a powder that needs to be dissolved in water.

In U.S. Pat. No. 4,505,732 another attempt to create increased resorption of micro-nutrients in plants is described. The micro-nutrients are mixed with chelat or complex forming compounds and dried upon particles of a water soluble polymer. A surfactant is included to enhance water solubility of the preparation.

EP 0 284 339 describes the use of leonardite ore, or rather a fraction of leonardite ore, in combination with EDTA, or similar sesquestrants, to create increased resorption of the micro-nutrient.

A suspension of the micro-nutrient in a composition containing a surfactant and a thickening agent is described in EP 0 485 225 B1. WO 99/26898 describes the use of derivatives of EDTA and N-acyl derivatives, for the increase of resorption of plant micro-nutrients.

In PL 167383 the increase of resorption of micro-nutrients is generated by the use of chelating agents such as cysteine, glutamic acid and citric acid.

### SUMMARY OF THE INVENTION

In a first aspect the present invention relates to a composition for resorption of micro-nutrients in plants, or pre-stages thereof, containing a micro-nutrient agent, an organic acid and an amino acid, said composition being obtainable by addition of at least one oxidizing agent during preparation of the composition, for oxidation of the micro-nutrient agent.

In one embodiment the micro-nutrient agent comprises an ion of an element selected from the group consisting of Cu, Mn, Mo, B, Fe, Zn, Co, Al, V, Se and Ni. In another embodiment the micro-nutrient agent comprises an ion of an element selected from the group consisting of Cu, Mn, Mo, Fe, Zn, Co, och Ni.

In still another embodiment the organic acid is a di- or tribasic carboxylic acid. In yet another embodiment the organic acid is selected from the group consisting of lactic acid, glycolic acid and citric acid.

In one embodiment the amino acid is soluble in polar solvents. In another embodiment the amino acid is methionine or lysine.

In yet another embodiment the oxidizing agent is selected from the group consisting of periodic acid, perboric acid and hydrogen peroxide. In still another embodiment the oxidizing agent is hydrogen peroxide.

In one embodiment at least one growth and uptake stimulating agent is added to the composition. In another embodiment the growth and uptake stimulating agent is urea.

In still another embodiment at least one macro-nutrient agent is added to the composition. In yet another embodiment the macro-nutrient agent comprises an ion of an element selected from the group consisting of N, P, K, Ca, Mg, S, Na and Si.

In one embodiment at least one non-metal micro-nutrient agent is added to the composition. In another embodiment the non-metal micro-nutrient agent comprises an ion of an element selected from the group consisting of B, Cl, F, I and Se.

In one embodiment at least one agent for treatment of bacterial and fungal diseases of plants is mixed with the composition.

In a second aspect the present invention relates to a method of producing a composition for resorption of micro-nutrients in plants, or pre-stages thereof, containing a micro-nutrient agent, an organic acid and an amino acid, said method comprising the steps of

dissolution of at least one micro-nutrient agent and at least one organic acid in a polar solvent;

addition of at least one oxidizing agent; and

addition of at least one amino acid.

In one embodiment the oxidizing agent is added after complete dissolution of the micro-nutrient agent.

In another embodiment the temperature is kept below 60° C. during the oxidation of the micro-nutrient agent and the addition of the amino acid.

In yet another embodiment the starting temperature before addition of the amino acid is below 42° C.

In still another embodiment the solvent is water or mixtures of water and at lest one lower alcohol.

In a further embodiment the lower alcohol is selected from the group consisting of methanol, ethanol, propylene glycol, glycerol, mannitol and xylitol.

In a third aspect the present invention relates to the use of a composition according to the invention or a composition produced by a method according to the invention, for resorption of micro-nutrients in plants, or prestages thereof.

### DETAILED DESCRIPTION OF THE INVENTION

In the present invention the problem of resorption of a micro-nutrient in a plant, as described earlier in this application, has been solved by a novel technique in which the micro-nutrient is made more readily available to the plant, or the pre-stages thereof (By “pre-stages thereof” referred to herein is meant seed, sprout, cutting, seedling, artificial seed and meristem tissue(s) and plants). This is accomplished by oxidation of the micronutrient(s) and by the formation of a complex of the micro-nutrient(s) with the components of the composition, preferably between the micro-nutrient(s) and the organic and amino acid.

The mechanism underlying the invention is not at present fully understood.

Materials

The composition of the present invention comprises, in its most fundamental form, at least one micro-nutrient agent, at least one organic acid, at least one amino acid and at least one oxidizing agent.

The solvents used in the process are preferably polar solvents and suitable candidates are water and mixtures of water and lower alcohols such as ethanol, methanol, propylene glycol, glycerol, mannitol and xylitol.

Organic acids within the meaning of the present invention are defined as acids with one or more carboxylic groups having preferably up to 6 carbon atoms in chain length. The acids may or may not be substituted by e g one or more hydroxylic groups.

The organic acid(s) used is preferably selected from the group of tri- or dibasic carboxylic acids. Without restricting the scope of the invention examples of such acids are citric acid, lactic acid and glycolic acid. The organic acid is preferably present-in an amount of 5-90 kg, more preferably 10-70 kg, and most preferably 20-50 kg per 1000 l of the composition.

The micro-nutrient(s) are selected from the following group of elements comprising Cu, Mn, Mo, Fe, Zn, Co, Al, V, and Ni. The preferred amounts of the micro-nutrients are Cu 0.1-200 , Mn 0.1-200, Mo 0.01-0.25, Fe 0.1-150, Zn 0.01-300, Co 0.01-3, Al 0.01-5 , V 0.01-5, and Ni 0.01-5 g/l composition.

The oxidizing agent(s) is preferably a water soluble substance. The preferred concentration of the oxidizing agent is 5-120 l, more preferably 10-90 l, and most preferably 15-60 l per 1000 l of the composition. Examples are periodic acid, hydrogen peroxide and perboric acid.

Amino acids within the meaning of the present invention are defined conventionally as a class of important organic acids which contain both a carboxylic and amino group.

The amino acid(s) added is selected by solubility in the earlier defined solvents and by availability. Non restricting examples of suitable amino acids are methionine and lysine. The preferred amount of amino acid is 1-30 kg/1500 kg composition=0.00067-0.02%, more preferably 5-20 kg/1500 kg composition=0.0033-0.0133% and most preferably 7-15 kg/1500 kg composition=0.00467-0.01%.

A growth and uptake stimulating agent can preferably be added to the composition. It should be soluble in water and in mixtures of water and other polar solvents. Such agents are known to a person skilled in the art. One example is urea.

Methods

The organic acid is dissolved in the solvent and the micro-nutrient agent(s) is added and dissolved while stirring in a suitable reaction vessel. When the micro-nutrient agent(s) is completely dissolved the oxidizing agent is added. The temperature should not exceed 60° C. during the oxidation. After completion of the reaction the amino acid(s) is added to the reaction vessel. The temperature must not exceed 60° C. during this step of the method and the starting temperature should preferably not exceed 42° C. The mixture is then stirred.

When the reaction is completed other ingredients as defined under detailed description and below can be added to the composition of the present invention. Suitable mixing times and intensities will have to be selected based on which types of other ingredients that are added and based on information known to the person skilled in the art. Preferred mixing times and temperatures are listed in Table 1 below.

Other ingredients, which are of benefit to the plant growth and plant health, is macro-nutrients (N, P, K, Ca, Mg, S, Na and Si), non-metal micro-nutrients (B, Cl, F, I and Se), growth and uptake stimulating agents such as but not restricted to urea and other ammonium compounds, wetting agents in order to make the wax layer more permeable to the nutrients and increase the contact surface of the nutrients with the plant-tissue such as but not restricted to non-ionic polyalkylene-oxide modified primary alcohols and polymers for the control of viscosity of the formulation. These other benificial ingredients are preferably added after the oxidation of the micro-nutrient agent(s). Preferred amounts of macro-nutrients are for N 10-400, P 10-100, K 10-300, Ca 10-300, Mg 1-100, S 1-200, Na 10-500 and Si 1-500 g/l composition. Preferred amounts of non-metal micro-nutrients are for B 6.1-150, Cl 1-500, F 0.01-5 and I 0.01-5 and Se 0.01-200 g/l

The composition of the invention is also miscible with commercial formulations of insecticides, herbicides, fungicides. This means that the product can be applied together with other crop protection products using e.g. a field sprayer where the products are dissolved and under agitation during the application, in a seed treater where the other seed protectants as bactericides, fungicides and or insecticides are added in a pre-mix or as a simultaneous treatment where the protectants are added in the treatment zone or other application technique suitable for the plant or “pre-stages” thereof treated.

### EXAMPLES

### Example 1

For the production of 1000 l of the composition of the present invention 31 kg citric acid (98.9%), at a temperature of 8-12° C., and 540 kg manganese sulphate (manganese 31-32%) were mixed with 780 l of water, at a temperature of 10-15° C. The reaction was carried out at a temperature of 40° C. for 25 minutes. 27 l of hydrogen peroxide (30%) was then added to the solution, which was stirred for 40 minutes at a temperature of 40° C. Then, 8 kg of methionine (99.8%) was added at a temperature of 45° C. and mixed for 35 minutes. Finally 99 kg of urea (46%) was added at a temperature of 41.2° C. to the solution, which was then mixed for 50 minutes. Table 1 discloses the process parameters used in the production in Example 1.

TABLE 1
Process parameters

| | Temp | Mixing/reaction time |
|---|---|---|
| Process step | (° C.) | (min) |
| Dissolution of citric acid | 10-15 | |
| Dissolution of manganese | 40 | 25 |
| sulphate | | |
| Oxidation reaction with H₂O₂ | 40 | 40 |
| Dissolution of methionine | 45 | 35 |
| Dissolution of urea | 41 | 50 |

When necessary, the composition was filtered through a suitable filter of a quality based on information well known to the person skilled in the art.

Test Method—Foliage Application

The composition manufactured according to Example 1 was tested regarding resorption of micro-nutrient(s) to plants. Field trials where conducted at different locations in Sweden using oats. The stages of application is prior to seeding of any “pre-stages” of plants or during latter stages of the plant, from 2-3 three leaf stage up to heading time. The formulation has been applied to the foliage by spraying. For comparison plants have been sprayed with both a commercially available standard product (Mantrac 500 from Phosyn, a suspension of manganese-carbonate and sulphate) and with a composition according to the present invention. Untreated plants were used as control plants.

The symptoms of deficiency have been monitored both as a “visual” assessment on “yellow” leaf areas or as other typical leaf symptoms known for the deficiency of specific disorders of micro-nutrients and as the content of micro-nutrients in the plants expressed as amount of micro-nutrients per dry matter weight and as content in the plant sap (The analyses of content of mirco-nutrients were conducted both as content per dry matter by HM-Miljölab, Kalmar, Sweden and in the plant sap by LMI AB, Helsingborg, Sweden.) The crop yield has been monitored as well. The results are shown in Tables 2-4 below.

TABLE 2
Increase in dry weight after treatment of crop
with a micro-nutrient composition according to example 1
in comparison with a commercial product.
The treatment was conducted on Jun. 14, 2000

| | Rate of | | | |
|---|---|---|---|---|
| | application | Dry weight (g) | | |
| Treatment | g/ha | June 14* | June 26 | July 3 |
| Untreated | | 8.6 | 13.2 | 10.7 |
| Standard product | 500 | 8.6 | 12.9 | 11.2 |
| The invention | 200 | 8.6 | 13.7 | 12.7 |

*before treatment

TABLE 3
Concentration of manganese in crop after treatment with a
product according to example 1 compared with a commercial product.
The treatment was conducted on Jun. 14, 2000

| | Rate of | Conc of Mn | | |
|---|---|---|---|---|
| | application | (mg/kg dry substance) | | |
| Treatment | g/ha | June 14* | June 26 | July 3 |
| Untreated | | 8 | 12 | 10 |
| Standard product | 500 | 8 | 21 | 19 |
| Invented product | 200 | 8 | 27 | 21 |

*before treatment

TABLE 4
Crop yield after treatment with a product manufactured
according to example 1 in comparison with a commercial
micro-nutrient product and a non treated area.

| | Yield kg/ha |
|---|---|
| Untreated | 190 |
| Standard product | 1250 |
| Invented product | 2010 |

Conclusion

Analysis after treatment with the composition of the present invention show an increased content of the micro-nutrient in the plant. The increased yield and growth of seedlings show that the plant has utilised and benefited from the treatment. The effect of treatment of plants with this product is higher yield and the reversal of the symptoms of manganese deficiency, yellowing leaves etc.

Test Method—Seed Application

The composition according to the invention was applied to barley and oat seed. For comparison seed were also sprayed with a commercially available standard product (CUTONIC® Mn Primer 500 g/l) and with a composition according to the present invention. Untreated plants were used as control plants.

Green-house trials were conducted evaluating the seedling and plant development at early stages. The formulation was applied to the seed prior to seeding in soil Analysis results appear from Table 5 and 6 below.

TABLE 5
Assay for Mn in barley seed treated with the
composition according to Example 1 in comparison with a
commercially available Mn carbonate product.

| | Rate of | |
|---|---|---|
| | application | Content of Mn |
| | (mg/kg seed) | (mg/kg dry substance) |
| Untreated | | 75 |
| Standard product | 1000 | 288 |
| Invented product | 100 | 316 |

TABLE 6
Plant growth after treatment of oat seed with
the composition according to Example 1 in comparison with
a standard commercially available product.

| Height of plant | 15-24 cm | 25-35 cm | 36-40 cm | 40-44 cm |
|---|---|---|---|---|
| Untreated | 7 | 85 | 114 | |
| Standard product | 5 | 70 | 123 | |
| Invented product | | 34 | | 161 |

Conclusions

A clear growth response was observed with plants earlier and faster developing. As a seed application in conjunction with application of the standard biological or chemical seed treatment products to control seed and soil-borne diseases a clear improved effect against these diseases has been observed in green-house trials.

### Example 2

### Gotland

Oat was grown on a location on Gotland, Sweden, with severe manganese conditions. Low rates of manganese in the soil and high pH in organic soil with a content of organic matter higher than 20%.

The invention, Microplan™ Manganese (150 gram manganese complex bound per liter, amino acids used were methionin and lysine, respectively), was applied to the foliage at growing stage DC 25 (early tillering). Manganese—80% EDTA (LMI, Helsingorg Sweden), Mangan 235 (Manganese Nitrate-BioMin, Gothenburg Sweden), Manganese sulphate (Erichem, Belgium) and Mantrac (Manganese carbonate-Phosyn, UK) were used for comparison.

The same amount of manganese was applied. The assessment, shown in the table 7 below, were done one week and two weeks after application. According to the following procedure: Manganese deficiency 0-100, scale 0=no deficiency 100=all plants/leaves showing deficiency (=yellow leaves).

TABLE 7
Manganese deficiency 0-100, scale 0 = no deficiency,
100 = all plants. The results are shown as
plant/leaf area with symptoms of manganese deficiency

| | 6/7-2001 | 16/7-2001 |
|---|---|---|
| Untreated | 89 | 89 |
| The invention - | 28 | 31 |
| methionin | | |
| 0.5 l/ha | | |
| 1.0 l/ha | 16 | 19 |
| 1.5 l/ha | 14 | 14 |
| The invention - lysine | 19 | 18 |
| 1.0 l/ha | | |
| Manganese - EDTA | 43 | 34 |
| 80% Mn 2.4 l/ha | | |
| Mn 235 | 38 | 38 |
| 1 l/ha | | |
| 1.5 l/ha | 35 | 32 |
| 2 l/ha | 35 | 34 |
| Manganese sulphate | 28 | 25 |
| 4 kg/ha | | |
| Mantrac | 53 | 59 |
| 1 l/ha | | |

Conclusions

The invention has a superior effect. Using organic acids and amino acids as a complex binding agent is much better than EDTA. The invention has a superior effect over manganese nitrate all rates, manganese sulphate at 4 kg/ha and manganese carbonate/sulphate suspension at 1 l/ha under very severe manganese deficiency.

### Example 3

### Foliage Application in Malting Barley, Zn

The object was to increase the amount of zinc in the grain, which is beneficial for the yeast fungi. Two compositions according to the present invention were used:

Microplan Malting Barley containing in g/l, methionine used as amino acid

| N | Mg | S | B | Cu | Fe | Mn | Mo | Na | Zn |
|---|---|---|---|---|---|---|---|---|---|
| 50 | 35 | 48 | 7 | 8.4 | 8.4 | 25 | 0.05 | 7 | 25 |

Microplan Zinc containing 180 gram zinc, 90 gram sulphate and 50 gram nitrogen per liter, methionine used as amino acid.

These solutions were compared in the experiment with standard products.

The products, which were compared with solutions according to the invention was Wuxal Suspension (chelated micro-nutrient product, Aglukon Spezialdunger Gmbh, Germany,), Zinctrac (suspension of carbonate/sulfate, Phosyn, UK)

The different products were applied at growing stage DC 47 (flag leaf fully developed). Analytical method SS 028311 developed at Växtekologiska Institutionen in Lund, using ICP=Integrated Coupled Plasma.

TABLE 8
Zinc per kg dry matter in the grain

| | Grain |
|---|---|
| | Zn mg/kg dry matter |
| Untreated | 33.2 |
| Wuxal suspensions 1 l + | 39.1 |
| Zinctrac 1 l | |
| Microplan Malting Barley 1 l + | 44.4 |
| Microplan Zinc 1 l | |

Conclusions

Microplan Malting Barley plus Microplan Zinc gives a bigger uptake of zinc in the grain compared to the standard products.

### Example 4

### Seed Treatment, Mn

Crop: Barley

Growth media: Soil from Stenstugu, Gotland, Sweden

Container: Plastic; surface 16.5×11.5 cm, height 21 cm.

Treatment: Entry A treated with 200 ml Fungazil A per 100 kg

Entry B treated with 200 ml Fungazil A+400 ml Microplan Manganese Seed (per 100 kg)

Sowing: 2001-08-13 with 50 seeds per container

Handling: The containers were kept outdoor during the experiment, under a translucent plastic roof. Water was added as needed.

TABLE 9
Emergence

| | Entry A | Entry B |
|---|---|---|
| Date | no plants | no plants |
| 17 Aug. | 28 | 43 |
| 18 Aug. | 45 | 48 |
| 19 Aug. | 45 | 49 |
| 10 Sep. | 48 | 50 |

As the containers were somewhat conical the plants could be taken out without harming the roots. The plants with soil were wetted with water so no loss of roots occurred. After the plants were free of soil, they were photographed. Several of the plants were in 4-leaves stage and some plants had started to tiller.

After the soil had been taken away carefully. The plants were separated from the roots and dried at 60° C. during 18 hours.

TABLE 10
Assessment of dry weight

| | Weight tot g | | Weight of 50 pl | | | | Total weight | |
|---|---|---|---|---|---|---|---|---|
| | leaves | roots | leaves | rel | roots | rel | | rel |
| Entry | (g) | (g) | (g) | fig | (g) | fig | (g) | fig |
| A | 2.05 | 1.31 | 2.14 | 100 | 1.36 | 100 | 3.50 | 100 |
| B | 2.73 | 1.74 | 2.73 | 128 | 1.74 | 128 | 4.47 | 128 |

Conclusions

The manganese treated plants had a slightly faster emergence and the development was better. More root and leaf mass was developed by the plants.

The dry weight increase is similar for roots and leaves. (128 compared to untreated)

### Example 5

### Winter Wheat Trials

The seed used was identical with the seed for the field trial in Gotland in Example 2.

Entry A Treated with Sibutol (fuberidazol, Biter-tanol) (fungicide seed treatment product)

Entry B Sibutol+300 ml Teprosyn (500 gram manganese carbonate/sulphate suspension liter, Phosyn, UK) per 100 kg.

Entry C Sibutol+300 ml Microplan Manganese (150 gram manganese complex bound per liter, according to the invention, lysine used as amino acid) per 100 kg

Sowing: 55 seeds per entry sown in plastic pots (16.5×11.5, hight 21 cm) in soil (Gotland)

Emergence: Emergence begun 29 September. Number of plants 1 October; A 45 pcs, B 43 pcs C 50 pcs (pcs=pieces or plants.

The pots were placed outdoors and water was applied as needed. The abnormal high temperatures during the summer of 2001 gave a quicker development than normal. The high temperature resulted in early attack of mildew around 20 September. The harvest had to be done already on 24 October. At harvest 90% of the plants were attacked.

TABLE 11
Results

| | No | Average length, (cm) | | | | % plants with | |
|---|---|---|---|---|---|---|---|
| Entry | plants | Root | Rel fig | Leaves | Rel fig | 2 leaves | 3 leavse |
| A | 52 | 23.04 | 100 | 23.48 | 100 | 33 | 67 |
| B | 51 | 24.41 | 106 | 23.28 | 99 | 37 | 63 |
| C | 53 | 25.96 | 113 | 23.71 | 100 | 34 | 66 |

Conclusions

As the harvest was done when the development was to start no reliable difference in dry matter can be evaluated. The total weight of 50 plants were only 2 g and the difference at most 0.02 g. The emergence was somewhat quicker with Microplan Manganese, the solution according to the invention with lysine as amino acid.

Especially the roots untreated were concentrated under the seed. As a rule only one root per seed had normal growth in the group of untreated. The root length in B and especially C were superior.

The rate of manganese applied per kg seed is only one third in Microplan Manganese, the solution according to the invention, compared to the standard product. This proves that the invention gives a very efficient uptake and utilizing of manganese.

TABLE 12
Plant analysis

| | Manganese | Increase over |
|---|---|---|
| | Mn/kg | untreated (%) |
| Untreated | 38 | |
| Teprosyn | 47 | 24 |
| The invention | 52 | 37 |

### Example 6

### Germination, Health and Emergence in Soil Spring Wheat Vinjett

The seed treatment fungicides Celeste, Panoctin, Cedemon were used alone and in combination with Microplan Manganese (see above), a solution according to the invention.

B=200 ml Celest,

C=200 ml Celest+300 ml Microplan Manganese,

D=400 ml Panoctine,

E=400 ml Panoctine+300 ml Microplan Manganese,

F=700 ml Cedomon,

G=1000 ml Cedomon,

H=1250 ml Cedomon,

I=1500 ml Cedomon,

J=1000 ml Cedomon +300 ml Microplan. Manganese

TABLE 13

| | | Germination % | | | Health % | | Emergence in soil % | | Attack by |
|---|---|---|---|---|---|---|---|---|---|
| Entry | | Normal | Abnorm | Dead | Fuarium | Septoria | Normal | Abnorm | fungi angr |
| A | Untreated | 98 | 1 | 1 | 0 | 59 | 92 | 4 | 38 |
| B | Celest | 95 | 3 | 2 | 0 | 12 | 88 | 5 | 5 |
| C | Celest + Mn | 96 | 3 | 1 | 0 | 9 | 92 | 4 | 11 |
| D | Panoctine | 97 | 2 | 1 | 0 | 13 | 93 | 2 | 24 |
| E | Panoctine + Mn | 95 | 3 | 2 | 0 | 9 | 94 | 3 | 28 |
| F | Cedomon 700 | 97 | 1 | 2 | 0 | 44 | 88 | 7 | 35 |
| G | Cedomon 1000 | 92 | 5 | 3 | 0 | 48 | 86 | 5 | 39 |
| H | Cedomon 1250 | 93 | 5 | 2 | 0 | 38 | 93 | 5 | 38 |
| I | Cedomon 1500 | 90 | 7 | 3 | 0 | 33 | 90 | 6 | 39 |
| J | Cedomon 1000 plus | 93 | 5 | 2 | 0 | 34 | 93 | 6 | 45 |
| | Mn | | | | | | | | |

Germination was done in rolled papers after 2 days at 10° C.+5 days at 20° C., 4×100. Health was done in rolled papers after 4 days at 10° C.+5 days at 20° C., 2×100. Emergence in soil was assessed after 7 days at 10° C.+5 days at 20° C., 2×100.

Conclusions

The effect against seed borne diseases are increased after addition of Microplan Manganese. This is probably an indirect effect as the plants treated with manganese get better root development, and stronger and faster growing plants.

1. A composition for resorption of micro-nutrients in plants, or pre-stages thereof, containing a micro-nutrient agent, an organic acid and an amino acid, said composition being obtained by
dissolution of at least one micro-nutrient agent and at least one organic acid, selected from the group consisting of lactic acid, glycolic acid and citric acid, in a polar solvent;
addition of hydrogen peroxide;
then, after complete reaction with the hydrogen peroxide, addition of at least one amino acid, which is soluble in polar solvents; and
maintenance of the temperature below 60° C. during the oxidation of the micro-nutrient agent and the addition of the amino acid.

2. A composition according to claim 1, wherein the micro-nutrient agent comprises an ion of an element selected from the group consisting of Cu, Mn, Mo, Fe, Zn, Co, Al, V, and Ni.

3. A composition according to claim 1 or 2, wherein the micro-nutrient agent comprises an ion of an element selected from the group consisting of Cu, Mn, Mo, Fe, Zn, Co, Na and Ni.

4. A composition according to any one of claims 1-3, wherein the amino acid is methionine or lysine.

5. A composition according to any one of claim 1-4, wherein at least one growth and uptake stimulating agent is added to the composition.

6. A composition according to claim 5, wherein the growth and uptake stimulating agent is urea.

7. A composition according to any one of claims 1-6, wherein at least one macro-nutrient agent is added to the composition.

8. A composition according to claim 7, wherein the macro-nutrient agent comprises an ion of an element selected from the group consisting of N, P, K, Ca, Mg, S, Na and Si.

9. A composition according to any one of claims 1-8, wherein at least one non-metal micro-nutrient agent is added to the composition.

10. A composition according to claim 9, wherein the non-metal micro-nutrient agent comprises an ion of an element selected from the group consisting of B, Cl, F, I and Se.

11. A composition according to any one of claims 1-10, wherein at least one agent for treatment of bacterial and fungal diseases of plants is mixed with the composition.

12. A method of producing a composition for resorption of micro-nutrients in plants, or pre-stages thereof, containing a micro-nutrient agent, an organic acid and an amino acid, said method comprising the steps of
dissolution of at least one micro-nutrient agent and at least one organic acid, selected from the group consisting of lactic acid, glycolic acid and citric acid, in a polar solvent;
addition of hydrogen peroxide;
then, after complete reaction with the hydrogen peroxide, addition of at least one amino acid, which is soluble in polar solvents; and
maintenance of the temperature below 60° C. during the oxidation of the micro-nutrient agent and the addition of the amino acid.

13. A method according to claim 12, wherein the oxidizing agent is added after complete dissolution of the micro-nutrient agent.

14. A method according to any one of claims 12-13, wherein the starting temperature before addition of the amino acid is below 42° C.

15. A method according to any one of claims 12-14, wherein the solvent is water or mixtures of water and at lest one lower alcohol.

16. A method according to any one of claims 15, wherein the lower alcohol is selected from the group consisting of methanol, ethanol, propylene glycol, glycerol, mannitol and xylitol.

17. Use of a composition according to claims 1-11 or a composition produced by a method according to claims 12-16, for resorption of micro-nutrients in plants, or pre-stages thereof.
